(19) United States
(12) Patent Application Publication
(10) Pub. No.: US 2025/0108343 A1
(43) Pub. Date: Apr. 3, 2025

(54) APPARATUS AND METHOD FOR GENERATING A MICROFOAM

(71) Applicant: Triple Line Technology Limited, Cambridge (GB)

(72) Inventors: Mark NICMANIS, Cambridge (GB); Michelle GOTHARD, Royston (GB)

(21) Appl. No.: 18/730,047

(22) PCT Filed: Jan. 11, 2023
(86) PCT No.: PCT/GB2023/050041

§ 371 Date: Jul. 18, 2024

(30) Foreign Application Priority Data
Jan. 25, 2022 (GB) 2200902.1

(51) Int. Cl. B01F 23/235; B01F 25/431

(52) U.S. Cl. CPC B01F 23/235; B01F 25/43172; B01F 25/431971

(57) ABSTRACT

An apparatus (10) for generating a microfoam, the apparatus comprising a first channel (12) having an inlet (11) and an outlet (13), a source of foamable fluid and a source of pressurised gas arranged to feed into the inlet, mix together and flow along the channel to the outlet, the direction from the inlet to the outlet defining a bulk flow direction, along which channel a microfoam is formed from the mixture; wherein the channel comprises a bulk flow stream (22) that is substantially parallel to the bulk flow direction, and a plurality of deviation points (24), each deviation point having a paired joining point (25), spaced along the bulk flow stream; each deviation point inducing a deviating portion of the bulk flow stream to be redirected away from the bulk flow stream; the deviating portion reaching a fluidic dead-end and encountering a counter-flow of fluid, such that, in use, the fluidic dead-end induces a reversed deviating portion of the bulk flow stream directed towards the bulk flow stream; the reversed deviating portion reaching the paired joining point where it rejoins the bulk flow stream before continuing until reaching the next pair of deviation and joining points; the shear forces induced by the deviations of the bulk flow stream inducing formation of the microfoam by interaction of the pressurised gas and foamable liquid.

### TECHNICAL FIELD

The present invention relates to a method and apparatus for generating a microfoam utilising a channel having an inlet and an outlet.

### BACKGROUND AND PRIOR ART

Foams are two phase systems which consist of a continuous liquid or solid phase that surrounds discrete gas entities. The continuous phase of a foam typically contains a surfactant or stabiliser which prevents the bubbles from coalescing and hence hinders the bubbles from reverting back to a continuous gas phase and separating out of the foam. Microfoams can be defined as a special case of foams wherein the bubbles are typically smaller than 100 microns and have a low polydispersity (e.g. a standard deviation of less than 40 microns).

Methods and apparatuses for generating microfoams are known.

Mechanical whipping relies on the use of mechanical moving parts to use mechanical shear to reduce the bubble size, for example in a high shear mixer. Such mixers rely on rotation of a high-speed impeller or beater head to mix different phases and other ingredients. Head speeds in these devices are typically greater than 10,000 rpm.

Thus, known methods of generating microfoams are fairly expensive and bulky to manufacture and are not convenient for use as a disposable item for example as part of consumer packaging.

Microfoams can also be generated by aerosol cans containing dissolved or liquefied gas propellants. However these are increasingly being perceived as problematic both environmentally and from a health and safety perspective. An example of this is provided in US 2015/0239645 A1.

Devices that can create a foam are known that utilise the well-known Rayleigh-Plateau phenomenon of forcing a fluid through a narrow aperture and allowing it to subsequently expand, with individual bubble necking off in a repeating process. However these methods are inconvenient for generating a fine microfoam as the bubble size is essentially governed by the aperture size, and apertures small enough to generate a microfoam would provide too great a fluid resistance for flow. Examples of these are given in US2015/0165392.

US2013/0175306 discloses a valve for forming a foam from a fluid, wherein the valve 5 comprises a number of barriers in a chamber wherein the barriers include an aperture, and a foam is generated by ensuring a highly turbulent environment.

US2015/0360853 A1 discloses a method of generating a microfoam by feeding a foamable liquid and a pressurised gas through a packed column. However a packed column is inconvenient as it can create dead zones which raise hygiene issues. This is believed to be primarily due to the multiple pathways that the fluid can flow along, inevitably producing preferred routes for flow over others. It is also difficult to manufacture the packed columns to the required specification, and parts of the packed column can become detached and contaminate the product stream.

WO2018/158560 discloses an apparatus for generating a microfoam that comprises a spatially oscillating flow channel, the oscillation induces foam generation due to the oscillation being such that cross-sections of the channel do not overlap and that the channel is a single channel with no splits or re-merging.

Mixing devices that have an expanding and contracting central channel are known (e.g. GB 1340913 and U.S. Pat. No. 4,964,733). Additionally, static mixers are known, (e.g. US 2014/0102706 A1). However none of these types of device can be operated to generate microfoams.

Further improvements in this area would be desirable.

### SUMMARY OF THE INVENTION

In a first aspect, the invention relates to an apparatus for generating a microfoam, the apparatus comprising a first channel having an inlet and an outlet, a source of foamable fluid and a source of pressurised gas arranged to feed into the inlet, mix together and flow along the channel to the outlet, the direction from the inlet to the outlet defining a bulk flow direction, along which channel a microfoam is formed from the mixture; wherein the channel comprises a bulk flow stream that is substantially parallel to the bulk flow direction, and a plurality of deviation points, each deviation point having a paired joining point, spaced along the bulk flow stream; each deviation point inducing a deviating portion of the bulk flow stream to be redirected away from the bulk flow stream; the deviating portion reaching a fluidic dead-end and encountering a counter-flow of fluid, such that, in use, the fluidic dead-end induces a reversed deviating portion of the bulk flow stream directed towards the bulk flow stream; the reversed deviating portion reaching the paired joining point where it rejoins the bulk flow stream before continuing until reaching the next pair of deviation and joining points; the shear forces induced by the deviations of the bulk flow stream inducing formation of the microfoam by interaction of the pressurised gas and foamable liquid.

A fluidic dead-end is provided when the deviating portion encounters a counter-flow of fluid, e.g. a flow of fluid in the opposite direction and of substantially equal momentum, the counter-flow causing turbulence, thereby causing the flow of the deviated portion to essentially cease, and to create a reversed deviating portion. The shear forces involved in the fluidic dead-end are believed to contribute to the generation of the microfoam.

Preferably each deviation point induces the deviating portion of the bulk flow stream to be redirected away from the bulk flow stream in a direction substantially perpendicular to the bulk flow stream, and the reversed deviating portion of the bulk flow stream is directed towards the bulk flow stream in a direction substantially perpendicular to the bulk flow stream.

The deviation points cause some or all of the bulk flow stream to flow in a direction that does not substantially progress the flow from the inlet to the outlet and instead acts as a flow disrupting feature. The disruption of flow is also believed to contribute to the generation of the microfoam as the fluid passes through deviations towards the outlet. The deviation point therefore is provided by a physical edge, corner or surface of the channel that acts to redirect the flow.

Thus, the foamable liquid and pressurised gas flow along the channel in a bulk flow stream and interact with each other to form a microfoam due to the shear environment induced by the deviations from the bulk flow stream, the fluidic dead-ends and the paired rejoining points.

By “substantially perpendicular” it is meant that the fluid travels in a direction that is not substantially progressing its flow from the inlet to the outlet. Typically this will be in a direction that is at least 45° to the direction of the bulk flow stream, and preferably greater than 60°.

The apparatus is arranged so that there is no proliferation of flow channels, as the flow is directed to rejoin the bulk flow stream after being diverted. Therefore there are no dead-zones caused by preferential pathways arising. Put another way, each deviation point induces a split but each paired joining point induces a re-merging, resulting in no net increase in the number of flow stream options for the fluid.

The apparatus therefore takes a foamable fluid and a pressurised gas and converts a mixture of the two into a microfoam, without any moving parts in a simple physical arrangement. Microfoams can be defined as a special case of foams wherein the bubbles are smaller than 100 microns and have a low polydispersity (e.g. a standard deviation of less than 40 microns).

It is understood that the mechanism of action is based on the principle that the deviations induce a particularly disruptive form of flow that is believed to induce local shear forces that are sufficiently disruptive to generate a microfoam. Each pair of deviation and rejoining points provides some conversion of the mixture of foamable fluid and pressurised gas into a two-phase microfoam.

In one preferred embodiment, at each deviation point, the deviating portion comprises the entirety of the bulk flow stream. Thus, all of the bulk flow stream is deviated to travel substantially perpendicular to the bulk flow direction until it reaches the fluidic dead-end, where it ceases, and to create a reversed deviating portion which reaches a paired joining point where it travels as the bulk flow stream once more.

Alternatively, in a second preferred embodiment, at each deviation point, only a portion of the bulk flow stream is deviated and that which is not deviated continues in a direction substantially parallel to the bulk flow direction until it reaches the joining point where it merges with the reversed deviating portion to re-form the bulk flow stream. In this embodiment, only a portion of the bulk flow stream is thus deviated, but only a portion being diverted is sufficient disturbance to induce microfoam generation. Preferably, at each deviation point, at least 25% of the volumetric flow of the bulk flow stream is deviated into a deviated portion, more preferably at least 50%.

In a first arrangement, the apparatus consists only of the first channel, and each fluidic dead-end is induced by a physical dead-end, which may conveniently be the wall of the channel. As the deviating portion cannot continue, it becomes the reversed deviating portion, which acts as the counter-flow of fluid.

However, in a second alternative arrangement, the apparatus comprises a second channel, that shares the inlet and outlet with the first channel, the second channel defining a second bulk flow stream, that is substantially parallel to the bulk flow direction, and a plurality of deviation points, each deviation point having a paired joining point, spaced along the second bulk flow stream; each deviation point inducing a deviating portion of the second bulk flow stream to be redirected away from the second bulk flow stream in a direction substantially perpendicular to the second bulk flow stream; the deviating portion reaching a fluidic dead-end, such that, in use, the fluidic dead-end induces a reversed deviating portion of the second bulk flow stream directed towards the second bulk flow stream in a direction substantially perpendicular to the second bulk flow stream; the reversed deviating portion reaching the paired joining point where it rejoins the second bulk flow stream before continuing until reaching the next pair of deviation and joining points; wherein the deviating portions of the first and second bulk flow streams provide the respective counter-flows for their respective fluidic dead-ends.

Thus, in this second arrangement, the first and second channels are connected to each other by deviating channels, along which the deviating flows travel. The fluidic dead-end is provided by the oncoming deviating portion from the other channel.

In this embodiment some fluid may cross over from the first channel to the second channel and vice versa. Thus, fluid may travel from a first deviation point and re-merge with flow from the second joining point channel in the second bulk flow stream. However when this is occurring it should be expected that an approximately equal amount of fluid is flowing in the opposite sense. Preferably therefore, the net flow rate across each fluidic dead-end is substantially net zero, although it does not need to be.

In a convenient arrangement, the second channel is a substantial mirror-image of the first channel. In such an arrangement there is a convenient balance of fluid pressures in use, and each channel does not substantially fluidly interfere with the other channel.

This arrangement has been found to be particularly stable because of the symmetrical nature of the first and second channels. This symmetry results in neither flow channel being preferential, and since they are mirror-images of each other they present the same fluid resistance and so neither presents a preferred route for flow, and thus they share the flow from the inlet to the outlet equally.

For any given microfoam a particular range of gas-to-liquid-ratio will need to be achieved. This can easily be obtained by varying the source pressures and/or the resistances of the flow channels of the gas and fluid respectively using methods known to the person skilled in the art.

However, it has been found that the source of pressurised gas and the source of foamable fluid have a pressure of from 2 to 20 bar gauge, preferably from 3 to 15 bar gauge. Such pressures have been found to be appropriate for most combinations of pressurised gas and foamable fluid. The source of foamable fluid and the source of pressurised gas are typically contained within separate volumetric regions, the pressures within which may be the same or different. When it is desired to generate a microfoam, the contents of the volumetric regions, e.g. separate pressurised containers, are brought into fluid communication with the inlet, e.g. by opening a respective valve. Typically the pressure at the outlet will be ambient pressure, e.g. atmospheric pressure, the pressure difference providing the driving force for flow from the inlet to the outlet.

Because the apparatus does not involve moving parts it can be made relatively cheaply and at essentially any scale. This allows it to be used on small scale dispensing applications through to industrial applications, e.g. for foaming concrete or insulating material. In some manufacturing methods, e.g. 3D printing or injection moulding, the apparatus can be made from a single unitary piece. In other methods of manufacture, e.g. milling, the apparatus could be made from a main body having a lid, and thus be made from two pieces.

Preferably the bulk flow streams, deviating portions and reversed deviating portions all have directions that are in the same plane. In this respect the arrangement can be considered to have a two-dimensional aspect, as the flow of fluid is all in a single plane. The plane within which the fluid flows does have a thickness, so it is not strictly a two dimensional arrangement, but the bulk flow stream has no vector at an angle to the plane. In other words, the cross-sections of the flow channels all exist in a single two-dimensional plane having a thickness equal to the dimension of the cross-sections. This two-dimensional plane may be curved.

The bulk flow direction may be a straight line from the inlet to the outlet, however some bends or curves in the bulk flow stream are also possible, but are not necessary for the formation of the microfoam. If any bends or curves are present it is preferred that these are in the same plane as the planes in which the junctions redirect flow along the side flow channels and primary flow channels.

The cross-section of the bulk flow stream (i.e. in the plane perpendicular to its direction of flow), the deviated portion and reversed deviated portion may take a variety of shapes, however preferably it is a regular geometry, such as a circular, ovoid, or parallelogram, e.g. rectangular. Preferably, it is substantially rectangular.

It has been found that providing the average cross sectional area of the bulk flow stream is from 0.5 to 8 mm², preferably from 2 to 4 mm². In this range, the fluid experiences sufficient shear forces to induce its conversion into a microfoam.

It has been found to be preferable that the cross-section of the bulk flow stream, the deviated portion and the reversed deviated portion has a low aspect ratio and is not particularly elongate. Therefore, preferably the ratio of the length of the cross section (i.e. the maximum linear dimension) to that of the width (i.e. the maximum dimension that is perpendicular to the length) is less than 4.0, more preferably less than 3.0 and most preferably less than 2.0.

Preferably the first channel has at least 10 pairs of deviation points and joining points, more preferably at least 20 pairs of deviation and joining points. Each additional deviation point has the capability to increase the quality of the microfoam, especially in terms of reducing bubble size and producing a creamy stable microfoam. However, there is a diminishing returns effect, and additional deviations will produce a greater pressure drop across the apparatus. Therefore some compromise on the number of deviations is required.

The first channel therefore preferably has a length of from 10 to 300 mm, that being the length in the bulk flow direction.

The gas may comprise any gas that is not substantially liquified, and preferably also not substantially soluble in the foamable fluid at the system pressure and temperature, e.g. air or nitrogen at 10 bar and 20° C., and not a liquefiable gas, such as a hydrocarbon propellant. The gas therefore essentially or completely remains in its gaseous phase throughout the process of microfoam formation, without any phase change or dissolution.

The foamable fluid contains a continuous liquid phase, typically entirely liquid, although it may be a coarse foam (i.e. one where the bubbles are substantially greater than 100 microns, or greater than 200 or even 400 microns) or other two-phase flowable material, e.g. an emulsion or dispersion.

The microfoams produced by the invention can be defined as a special case of foams wherein the mean bubble diameter is less than 100 microns, or even less than 70 microns. A good quality microfoam also has a low polydispersity (e.g. a standard deviation of less than 40 microns). Typically the bubbles in a microfoam at low gas phase volumes will be spherical, and can become partially polygonal at higher gas phase volumes. As such their dimensions can be easily measured from visual imagery.

A microfoam producible by the present invention typically comprises a continuous liquid phase in a volume fraction of from 0.01 to 0.6, preferably from 0.05 to 0.3 with a dispersed gas phase with a volume fraction of from 0.99 to 0.4, preferably from 0.95 to 0.7.

Microfoams have many characteristics which make them relevant to a wide range of industrial, commercial, domestic and medical applications which include, but are not limited to: soap based foams, shaving foams, skin creams, sunscreens, coffee crema and latte foams, hair care products, surface cleaning formulations, whipped creams, dairy foams (including ice cream), culinary foams, bakery and confectionery products, thermal and acoustic insulation, building materials, lightweight packaging, space filling materials, topical drug delivery, haemostasis, sclerotherapy and formation of tissue scaffolds. A preferred microfoam is based on dairy products, e.g. milk and/or cream or synthetic equivalents.

Microfoams are also useful in processes where a large gas/liquid interfacial area may be beneficial for example in gas/liquid separation processes such as gas scrubbing or in gas/liquid reaction processes such as those occurring in fuel cells.

The apparatus may be formed from a wide range of materials including plastics (e.g. polypropylene, PET, polyethylene, ABS, nylon, PLA, PVC, Teflon™, Acrylic, polystyrene, PEEK etc) metals, glass, engineered fibre matrices or any other material that can be molded, milled, printed, cast, machined, sintered, etched, carved, forged, blown, pressed, stamped, electron beam machined, laser cut, laminated and formed into the appropriate shape.

In cases where a very low cost disposable (or perhaps single use) device is required then many of the plastics may be more suitable since they are low cost, may be recyclable, and suitable for high volume manufacturing methods such as injection moulding. A reusable device may be required in other applications, for example, a foam dispenser that dispenses hand sanitiser. In such cases metal, ceramic or glass (perhaps supported by a surrounding structure) may be more appropriate since they are more resistant to chemical and mechanical cleaning, heat treatments, steam cleaning, autoclaving and integration.

The current invention can be used as single geometric channels for the generation of low to medium volumetric flows of microfoam, or a number of foamer units can be run in parallel to achieve higher volumetric flows more suited to industrial and manufacturing applications.

In a second aspect, the present invention relates to a method for generating a microfoam, the method employing an apparatus described herein.

### BRIEF DESCRIPTION OF THE DRAWINGS

The invention will now be illustrated with reference to the following figures, in which:

FIG. 1 is a sectional plan view of an apparatus according to the present invention.

FIG. 2 is sectional plan view of a further apparatus according to the present invention.

FIG. 3 is sectional plan view of a further apparatus according to the present invention.

FIG. 4 is sectional plan view of a further apparatus according to the present invention.

FIG. 5 is sectional plan view of a further apparatus according to the present invention.

FIG. 6 is sectional plan view of a further apparatus according to the present invention.

FIGS. 7A to 70 are schematic representations of the geometries employed in the examples.

FIG. 8 is a schematic representation of the apparatus used in the examples.

FIG. 9 is a light micrograph of a microfoam formed by example geometry 29 in refillable aerosol configuration.

FIG. 10 is a chart showing the size distribution of gas bubbles in the microfoam shown in FIG. 9.

FIG. 11 is a side sectional view of a device according to the invention for delivering a microfoam.

FIG. 12 is a side sectional view of a variant of the device shown in FIG. 11 showing the cap assembly only.

FIG. 13 is a side sectional view of a second device according to the invention for delivering a microfoam.

### DETAILED DESCRIPTION

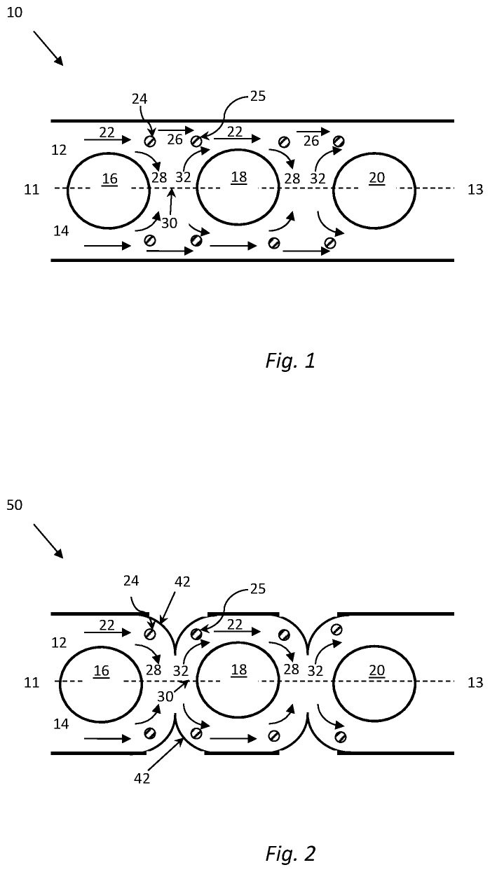

Turning to the figures, FIG. 1 shows an apparatus 10 for generating a microfoam, which comprises a first channel 12 and a second channel 14 sharing an inlet 11 and an outlet 13. Positioned in the channels 12, 14 are three cylindrical formations 16, 18, 20. It should be noted that only three formations 16, 18, 20 are shown for the purposes of illustration, and there will typically be a greater number than this between the inlet 11 and outlet 13. The arrangement is essentially 2-dimensional, so that the plan view shown is representative of the whole of the apparatus, and the cross-section for the fluid (i.e. in the plane perpendicular to its direction of flow) is rectangular.

The flow of foamable liquid and compressed gas in first channel 12 is indicated by bulk flow stream 22. As the fluid travels along the first channel 12, it reaches a first deviation point 24. At this point the bulk flow stream 22 splits into a deviated portion 28 and a non-deviated portion 26 that continues directly to the paired joining point 25. Note that, in the figure, the deviation point 24 and joining point 25 are shown as hatched to represent the fact that they are indicative of the location of the fluid deviation and joining, rather than representing a physical feature of the apparatus.

The deviated portion 28 deviates in a direction that is substantially perpendicular to the bulk flow stream 22 and eventually reaches a fluidic dead-end 30. In this case the deviated portion is at an angle of from 45 to 90° to the direction of the bulk flow stream 22.

The second channel 14 is a mirror-image of the first channel 12, and therefore behaves in the same manner. The fluidic dead-end 30 in this embodiment is brought about by the fact that the second channel 14 provides an equal flow of deviated flow from its side, thus preventing flow from passing the center-line 30 and so acting as a fluidic dead-end due to the mutually occurring counter-flows. This induces a reversed deviated portion 32 that also travels in a direction that is substantially perpendicular to the bulk flow stream 22. The reversed deviated portion 32 is essentially equal to the flow rate of deviated portion 28 and so the net result is that there is no net flow rate across fluidic dead-end 30, despite it providing a fluid connection between the first channel 12 and the second channel 14. The reversed deviated portion 32 reaches the paired joining point 25 where it rejoins and re-merges with non-deviated portion 26 to reform bulk flow stream 22. The shear environment induced in the fluid as it is forced to split and re-merge after deviating from its bulk flow direction induces the gradual formation of a microfoam as the fluid progresses along the first channel encountering such deviation and rejoining points.

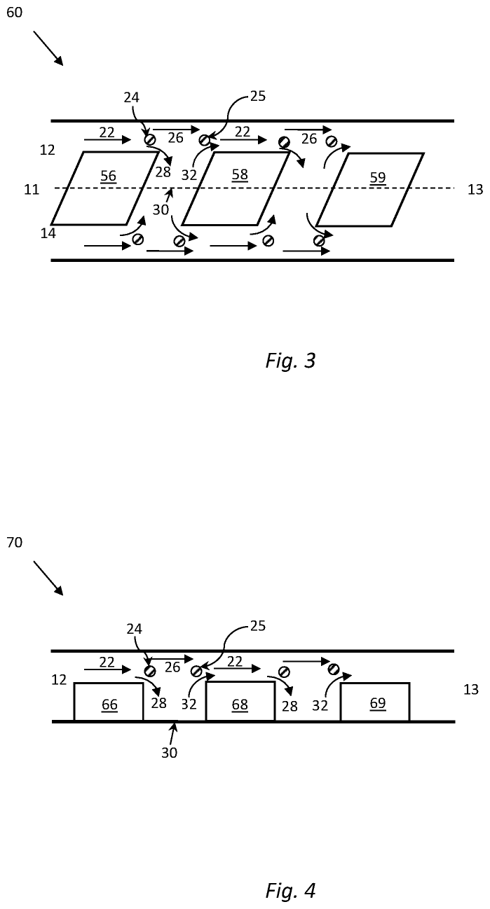

FIG. 2 shows another apparatus 50 according to the present invention that is generally similar to that shown in FIG. 1, and any features that remain the same retain the same reference numbers. In this case the outer walls of the first channel 12 and second channel 14 contain curved intrusions 42. As the fluid travels along first channel 12, as indicated by bulk flow stream 22, deviation point 24 is encountered. Due to the curved intrusions 42, the entirety of the bulk flow stream forms a deviated portion 28. The deviated portion 28 reaches fluidic dead-end 30 which induces a reversed deviated portion 32. The reversed deviated portion 32 is equal to the flow rate of deviated portion 28 and so the net result is that there is no net flow rate across fluidic dead-end 30. The reversed deviated portion 32 reaches the paired joining point 25 where it reforms into bulk flow stream 22.

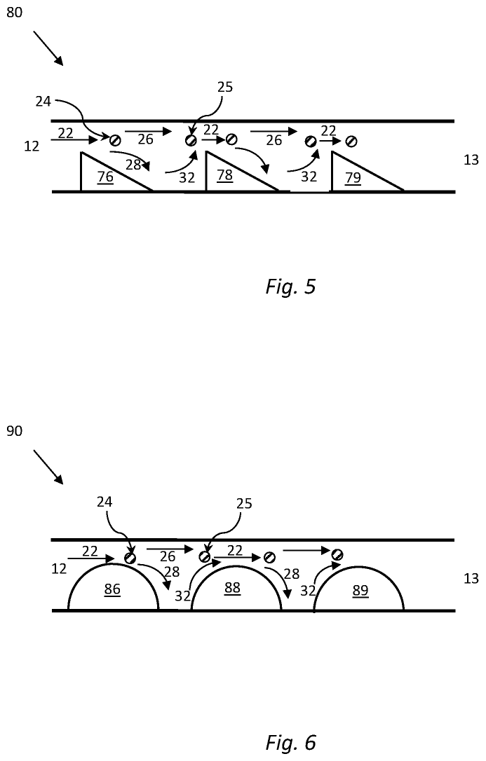

FIG. 3 shows another apparatus 60 according to the present invention that is generally similar to that shown in FIG. 1, and any features that remain the same retain the same reference numbers. In this case the cylindrical formations have been replaced with rhomboid formations 56, 58, 59. As the fluid travels along first channel 12, as indicated by bulk flow stream 22, deviation point 24 is encountered. At this point the bulk flow stream 22 splits into a deviated portion 28 and a non-deviated portion 26 that continues directly to the paired joining point 25. The deviated portion 28 reaches a fluidic dead-end 30 which induces reversed deviated portion 32. In view of the fact that the space between the rhomboid formations 56, 58, 59 is angled towards the perpendicular to the bulk flow stream 22, there will be some net flow across fluidic dead-end 30. Therefore, the reversed deviated portion 32 may be slightly greater than the flow rate of deviated portion 28 and so the net result is that there is some net flow rate across fluidic dead-end 30. The reversed deviated portion 32 reaches the paired joining point 25 where it rejoins and re-merges with non-deviated portion 26 to reform bulk flow stream 22.

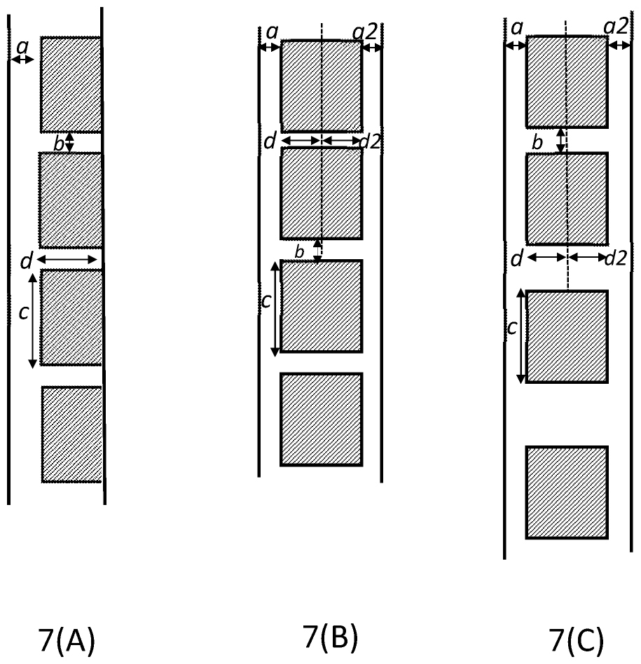

FIG. 4 shows another apparatus 70 according to the present invention that is generally similar to that shown in FIG. 1, and any features that remain the same retain the same reference numbers. In this case the apparatus comprises only one channel 12, and the cylindrical formations have been replaced with rectangular ones 66, 68, 69. As the fluid travels along the first channel 12, it reaches a first deviation point 24. At this point the bulk flow stream 22 splits into a deviated portion 28 and a non-deviated portion 26 that continues directly to the paired joining point 25. The deviated portion 28 reaches a wall 30 providing a fluidic dead-end. As the deviating portion 28 cannot continue, it becomes the reversed deviating portion 32, which acts as the counter-flow of fluid. The reversed deviated portion 32 is equal to the flow rate of deviated portion 28. The reversed deviated portion 32 reaches the paired joining point 25 where it rejoins and re-merges with non-deviated portion 26 to reform bulk flow stream 22. The shear environment induced in the fluid forces it to split and re-merge after deviating from its bulk flow direction induces the gradual formation of a microfoam as the fluid progresses along the first channel encountering such deviation and rejoining points.

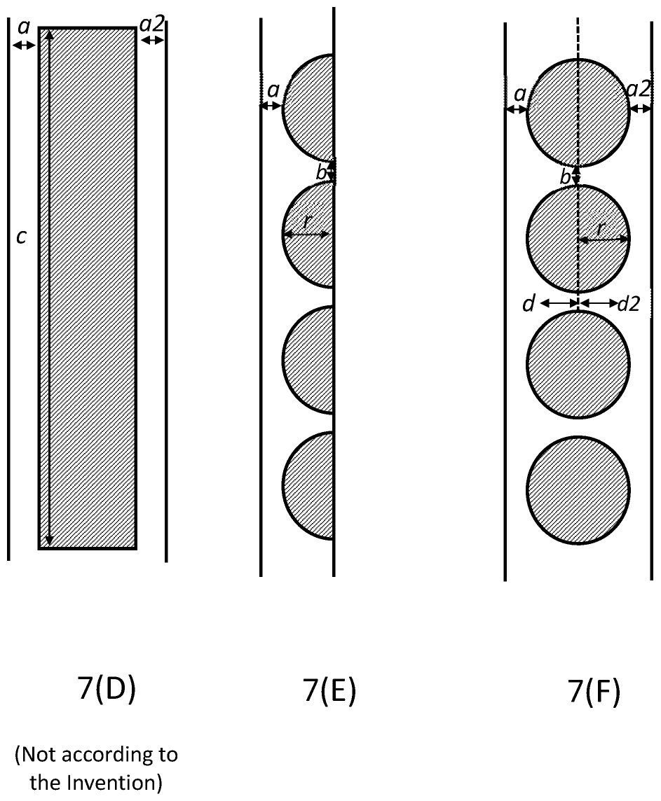

FIG. 5 shows a further apparatus 80 according to the present invention that is generally similar to that shown in FIG. 4, and any features that remain the same retain the same reference numbers. In this case the rectangular formations have been replaced with triangular formations 76, 78, 79. The operation of the apparatus is essentially the same as described in FIG. 4.

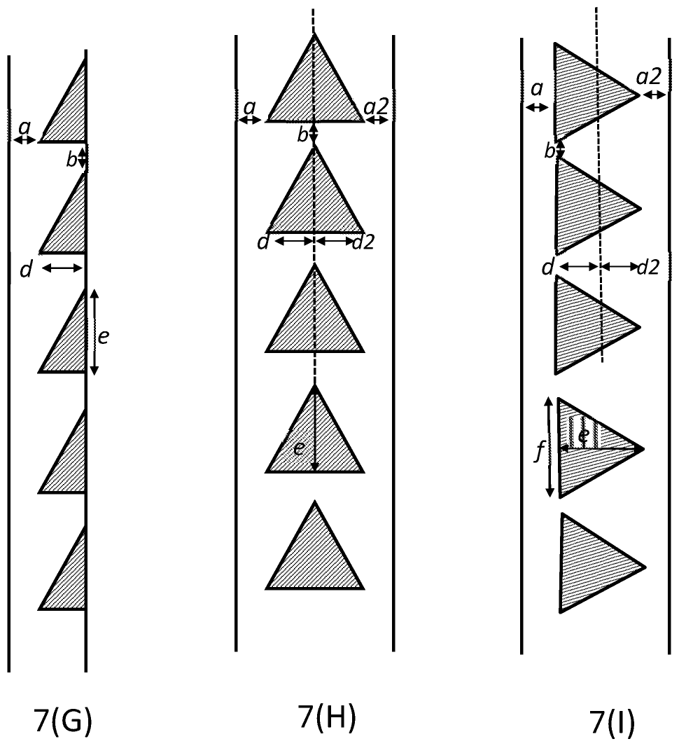

FIG. 6 shows a further apparatus 90 according to the present invention that is generally similar to that shown in FIG. 4, and any features that remain the same retain the same reference numbers. In this case the rectangular formations have been replaced with semi-circular formations 86, 88, 89. The operation of the apparatus is essentially the same as described in FIG. 4.

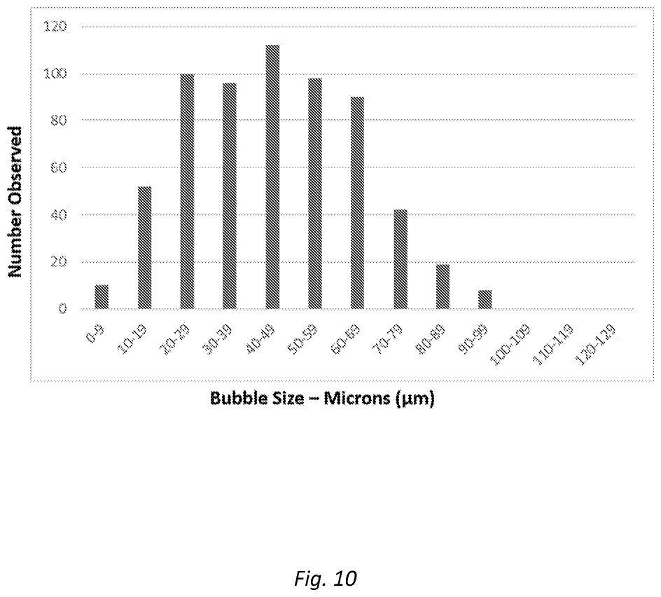

FIG. 11 illustrates an embodiment of a microfoam generating device comprising a pressurised container. These devices are rechargeable, refillable aerosols, although they could be disposable and could contain any gas as described herein.

The first embodiment of a rechargeable refillable aerosol in FIG. 11 comprises a retaining vessel 203, for holding a foamable fluid 200, a headspace of compressed gas 201, and a microfoaming section 205 with gas conduit 207. Additionally, there is a screw-fit cap assembly 211 with seal 210, incorporating a pressurised gas charging port 214 with one-way valve 215, and an actuated valve-spring assembly 216, 217 and nozzle 218 for the control and dispensing of microfoam.

The aerosol device shown in FIG. 11 is initially filled with a source of foamable fluid 200 at atmospheric pressure and in its own volumetric region, which in this case is a liquid. The cap assembly 211 is then applied to the retaining vessel 203 sealing the vessel contents from the external atmosphere via interlocking screw threads 212, a compressible seal 210, and closed valves 215, 216 within the flow paths of the pressurised gas charging port 214 and the nozzle 218 of the cap. The headspace 201 of the device is pressurised to the required level via connecting the high-pressure gas connector 213 to an external charging supply of the desired gas, and provides the source of pressurised gas in its own volumetric region. Charging supplies of gas may be provided by air pumps, gas compressors, pressurised gas header tanks, pressurised gas cylinders, and small volume pressurised gas bulbs. The charging gas passes through a one-way valve 215, allowing gas into, but not out of the device 202. The gas flow then passes into the retaining vessel 203 via the charging gas-microfoam channel junction 255, and then through the flow channel 204 within the microfoaming device 202. Use of the microfoam channel 204 and flow channel of the foaming section 205 as a common conduit for the charging gas has the advantage of the pressurised gas flow back-flushing the channels of obstructions from dried or accreted materials from the foamable fluid or contamination. Once the desired gas pressure has been obtained within the retaining vessel 203 the external gas supply may be disconnected from the high-pressure gas connector 213. Microfoams of the foamable liquid 200 is then produced by opening the actuated valve 216. The valve 216 and its return spring 217 can be actuated by a number of means known in the art, such as levers, triggers and buttons (not shown). Also, the position of the return spring 217 relative to the valve 216 may vary with respect to the choice of actuation design. Opening valve 216 allows a pressure release for the pressurised system within the retaining vessel 203. The pressure release results in the foamable fluid 200 flowing into the foaming device fluid inlet 206, and pressurised gas flowing into the inlet 209 of the gas conduit 207, which is positioned within the gas headspace clear of the foamable fluid level. The flows of pressurised gas in the gas conduit 207 and the foamable liquid from the inlet 206 meet at the gas-liquid junction 208, where the gas is incorporated into the liquid flow. The microfoam is then generated as the biphasic fluid flow passes through the channel 204 in the microfoaming device 202. The microfoam then flows out of the microfoaming device 202, through the microfoam flow channel 204 and the open valve 216. The microfoam finally exits the device through the nozzle 218. Microfoam generation ceases when the actuator (lever, trigger or button) is released and the valve return spring 217 closes valve 216 equalising the system pressure within the device 202.

This aerosol device can be recharged with gas at any time during use by connecting the sealed device to an external charging gas supply via the high-pressure gas connector 213. To refill the aerosol with foamable fluid, residual gas pressure is released by actuation of valve 216. Once the aerosol has equalised with atmospheric pressure the actuator is released, closing valve 216, and the cap can then be safely removed for refilling the device with foamable fluid.

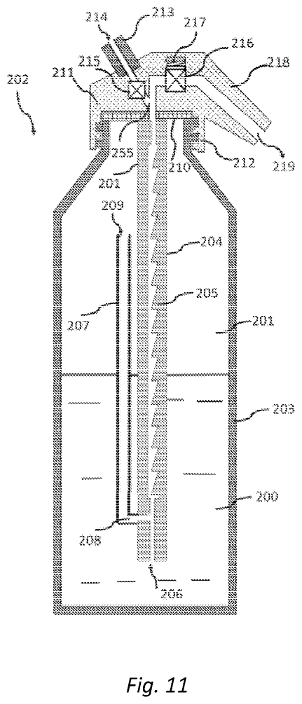

A variant of the cap assembly of the rechargeable, refillable aerosol embodiment illustrated in FIG. 11 can be seen in FIG. 12. FIG. 12 shows only the screw-threaded cap assembly 223, 224 of the entire device. In this variant, the charging gas flow from the pressurised gas charging port 225, 226 passes through a one-way valve 227, and then through the charging gas outlet 232 directly into the compressed gas headspace 201 (as shown in FIG. 11) through a separate aperture in the seal 222 without connection to the microfoam flow channel 256 via the charging gas-microfoam channel junction 255 (FIG. 11). All other aspects of the cap assembly 224, the quick release, high pressure gas connector 225, actuated valve and return spring 229, 228, nozzle 230, microfoaming section 221 with gas conduit (not shown), and microfoam exit flow 231, are as described for FIG. 11. Such a variant may be advantageous for systems where it is undesirable for the foamable fluid to undergo pre-shear and gasification prior to microfoaming, and also enables gas filling at a higher rate.

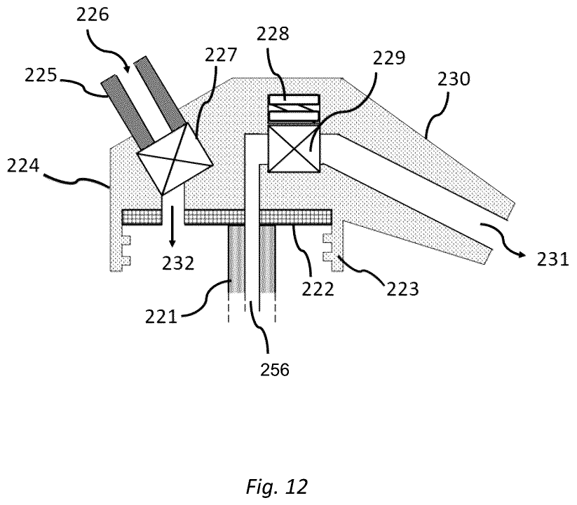

A second embodiment of a rechargeable refillable aerosol for the generation and dispensing of microfoams is illustrated in FIG. 13. This embodiment comprises a retaining vessel 236, for holding a foamable fluid 233, a headspace of compressed gas 234, and a dip tube 253 with gas conduit 240. Additionally, there is a screw-fit cap assembly 244, 245 with seal 243, incorporating a pressurised gas charging port 246, 247 with one-way valve 248, an actuated valve-spring assembly 249, 250 and nozzle 251 housing a microfoaming section 237. The microfoaming section 237 may be integral to the nozzle 251, but it may also be detachable to enable cleaning, replacement, or interchange with microfoaming sections of different design.

The retaining vessel 236 is initially filled with foamable fluid at atmospheric pressure. The cap assembly 244 is then applied to the retaining vessel 236 sealing the vessel contents from the external atmosphere 235 via interlocking screw threads 245, a compressible seal 243, and closed valves 248, 249 within the flow paths of the cap 247, 244. The headspace 234 of the device shown in FIG. 13 is pressurised to the required pressure via connecting the high-pressure gas connector 246 to an external charging supply of the desired gas. As for the first aerosol embodiment, charging supplies of gas may be provided by air pumps, gas compressors, pressurised gas header tanks, pressurised gas cylinders, and small volume pressurised gas bulbs. The charging gas passes through a one-way valve 248 and into the retaining vessel 236 via the charging gas-dip tube junction 254, and then through the dip tube 253 and gas conduit 240 and exiting at the dip tube inlet 239 and the gas conduit inlet 242. Once the desired gas pressure has been obtained within the retaining vessel 236 the external gas supply may be disconnected from the high-pressure gas connector 246.

Microfoams of the foamable liquid 233 are then produced by opening the actuated valve 249. The valve 249 and its return spring 250 can be actuated by a number of means known in the art, such as levers, triggers, electro-mechanical actuators and buttons (not shown). Also, the position of the return spring 250 relative to the valve 249 may vary with respect to the choice of actuation design. Opening valve 249 allows a pressure release for the pressurised system within the retaining vessel 236. The pressure release results in the foamable fluid 233 flowing into the dip tube inlet 239, and pressurised gas flowing into the inlet 242 of the gas conduit 240, which is positioned within the gas headspace clear of the foamable fluid level. The flows of pressurised gas in the gas conduit 240 and the dip tube inlet 239 meet at the gas-liquid junction 241, where the gas is incorporated into the liquid flow. The biphasic fluid flow passes through the dip tube 253 and open valve 249, then entering the flow path 238 of the microfoaming section 237 located in the nozzle 251 of the cap assembly 244. The generated microfoam finally flows out of the end of microfoaming section 237, and is dispensed for use. Microfoam generation ceases when the actuator (e.g. lever, trigger or button) is released and the valve return spring 250 closes valve 249, equalising the system pressure within the device.

The rechargeable, refillable aerosol device in FIG. 13 can be recharged with gas at any time during use by connecting the sealed device to an external charging gas supply via the high-pressure gas connector 246. To refill the aerosol with foamable fluid, residual gas pressure is released by actuation of valve 249. Once the aerosol has equalised with atmospheric pressure the actuator is released closing valve 249, and the cap can then be safely removed for refilling the device with foamable fluid.

A variant of the aerosol device in FIG. 13 can be made consistent with the changes in the charging gas flow path described in FIG. 12. In the case of this second embodiment (FIG. 13), the charging gas flow, from the quick release, high pressure gas connector 246, would enter directly into the pressurised headspace 234 through a dedicated charging gas outlet, and not flow in through the dip tube 253 via the charging gas-dip tube junction 254. Again, this design is advantageous for systems where it is undesirable for the foamable fluid to undergo, pre-shear and gasification prior to microfoaming, or where high speed gas filling is required.

Alternatively, the aerosol embodiments shown in FIGS. 11 and 13 may be filled with foamable fluid through the foamer outlet 252 or the foamer could be removed and foamable liquid could be filled through nozzle 251 with the actuated valve in the open position, negating the need to remove and replace the cap assembly. Alternatively foamable fluid could also be filled through the high pressure gas inlet port 246, 247 with the actuated valve 249 in the closed position.

Although not shown, in FIGS. 11, 12 and 13 a pressure release valve may be incorporated into the retaining vessel (FIG. 11, 203, FIG. 13, 236), or the cap assembly (FIG. 11, 211, FIG. 12, 224, and FIG. 13, 244), to prevent over-pressurisation and may additionally be used to depressurise the system prior to refilling with foamable fluid.

A further embodiment for the current invention is a non-refillable, non-rechargeable aerosol. Here the foaming sections depicted in FIG. 11, 205 and FIG. 13, 237 would take up similar respective positions within crimp-sealed aerosol with a single actuated valve assembly. Such aerosols may be filled with foamable fluid prior to application of the crimp-sealed cap assembly, or back through the actuated valve after the application of the crimp sealed cap assembly. The aerosols would be pressurised by filling with pressurised charging gas through the actuated valve assembly or directly into the retaining vessel prior to crimp sealing the valve assembly (under the cap filling).

Alternatively, the arrangement shown in FIG. 13 could comprise a bag containing the diptube 253, gas conduit 240 and foamable liquid 233. The foamer would still be integrated into the nozzle as shown in FIG. 13.

Alternatively, the arrangements shown in FIGS. 11 and 13 could be used in an inverted orientation, in which case, the gas inlets 209, 242 are interchanged with the liquid inlets 206, 239.

Alternatively, the arrangements shown in FIGS. 11 and 13 could be configured so that they are shaken (thus forming a coarse foam in the retaining vessel 203, 236 prior to dispensing the contents. In this case the coarse foam would enter the liquid and/or gas inlets 209, 242, 206, 239 possibly in combination with foamable liquid and/or gas. This coarse foam (and possibly gas and foamable liquid) would be converted into a microfoam as it passed through the microfoaming device 202. A further variation of this arrangement would utilise a single inlet to the microfoaming device which would be located in the coarse foam that resulted from shaking the device. In this configuration only coarse foam would enter the microfoaming device and be converted to microfoam as it passed through the device.

### Examples

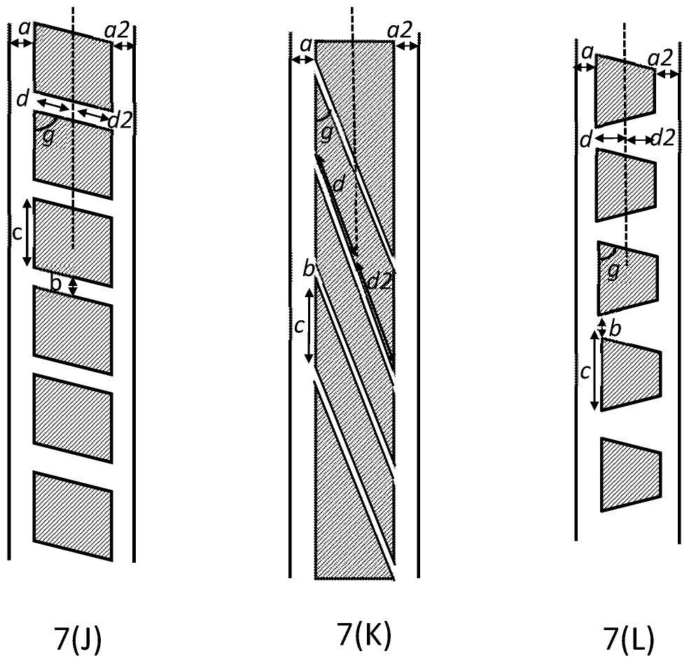

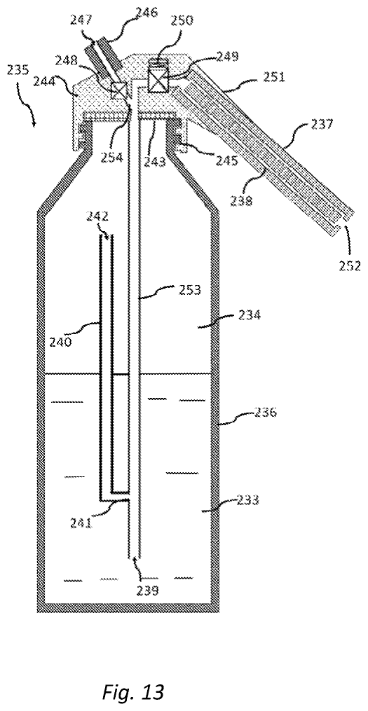

A number of experiments were carried out using the geometries illustrated in schematic form in FIGS. 7A to 70. It should be noted that D and M are not according to the invention.

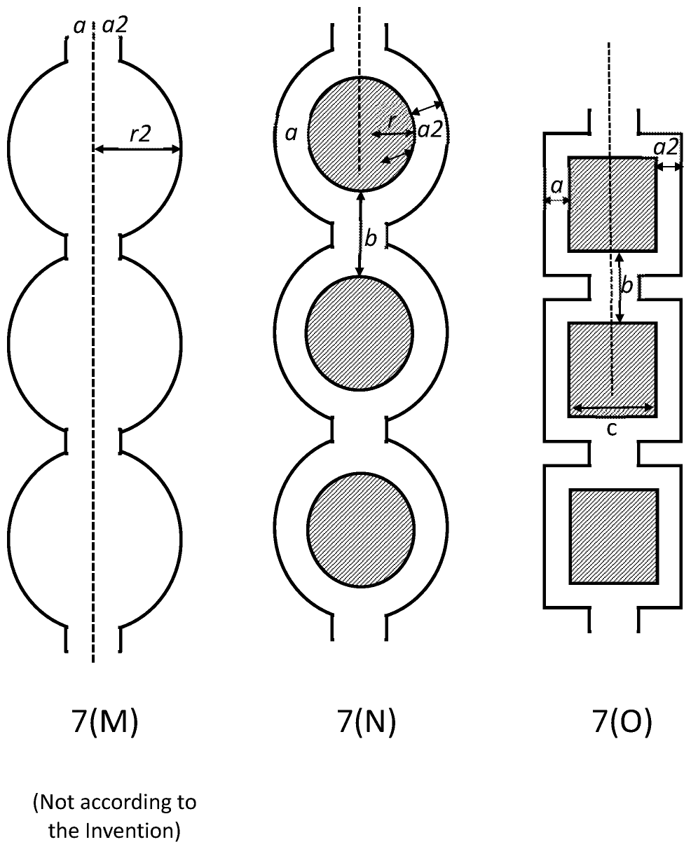

FIG. 8 shows a diagram of the experimental rig 100. A compressor 112 was used to supply pressurized air via 2.5 mm ID tubing 113 to a T-connector 114 which supplies pressurized air to a vessel containing foamable liquid 115 (the liquid vessel) and a vessel containing only gas 116 (the gas vessel). Tubing 113 (2.5 mm ID) connects the outlet of both vessels to a second T-connector 117 which was in turn connected (via 2.5 mm ID tubing) to the micro-foam generating device 118. The liquid vessel is oriented so that the tubing connected to the compressor feeds into the headspace of the liquid vessel and the tubing leading to the micro-foam generating devices is connected to the liquid vessel below the liquid line. In FIG. 8 connector 117 is a T-connector, however, a Y-connector or other geometry connector that provides the correct gas-liquid ratio, may be used, preferably as intermittent packets that span the gas-liquid conduit leading to the microfoam generating device.

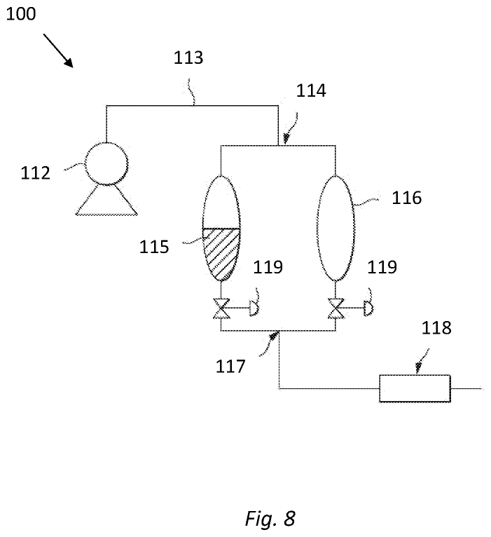

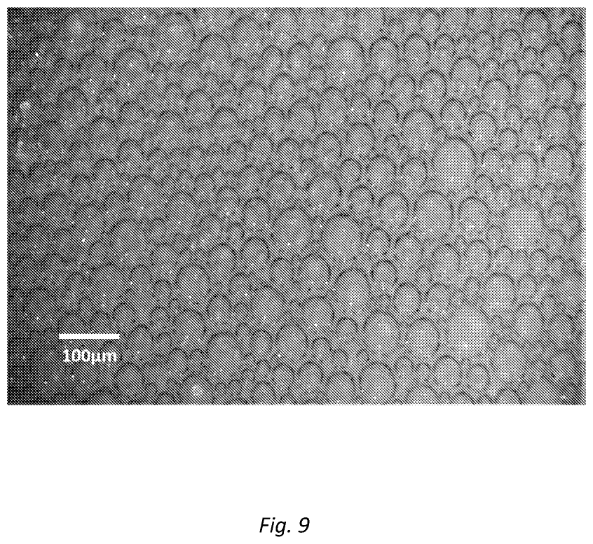

FIG. 9 is a light micrograph of a microfoam formed by example geometry 29 (shown in the tables below) in the refillable aerosol configuration and FIG. 10 is a chart showing the size distribution of gas bubbles in the microfoam shown in FIG. 8.

For each design the following terminology is used.

### For all Designs

Z—depth of channels
a—minimum width of the main bulk flow channel
a2—minimum width of the second bulk flow channel
b—width of fluidic dead end at minimum point
N—number of fluidic dead ends from the main bulk flow channel
N2—number of fluidic dead ends from the second bulk flow channel d—length of fluidic dead end from the main bulk flow channel
d2—length of fluidic dead end from the second bulk flow channel

### Designs A to D (Rectilinear)

C—distance between junction of fluidic dead end

### Designs E and F

r—radius of circular or semi-circular flow obstruction

### Designs G to I (Triangular)

e—length of triangle in direction of bulk flow
f—length of base of triangle as shown in FIG. 7(I)

### Designs J to L (Parallelograms, Rhomboids and Trapezoids)

g—acute angle as shown in 7(L)

### Designs M and N

r2—radius of bulk flow channels

The following tables list the details of the geometries tested:

| Example | Geometry | Z | a | a2 | b | | | d | d2 | C |
|---|---|---|---|---|---|---|---|---|---|---|
| No | Type | (mm) | (mm) | (mm) | (mm) | N | N2 | (mm) | (mm) | (mm) |
| 1 | A | 2 | 1 | none | 1 | 33 | NA | 2 | NA | 4 |
| 2 | A | 2 | 2 | none | 1 | 33 | NA | 2 | NA | 4 |
| 3 | A | 2 | 3 | none | 1 | 33 | NA | 2 | NA | 4 |
| 4 | B | 2 | 1 | 1 | 1 | 33 | 33 | 2 | 2 | 4 |
| 5 | B | 2 | 1 | 1 | 1 | 18 | 18 | 2 | 2 | 4 |
| 6 | B | 2 | 1 | 1 | 1 | 8 | 8 | 2 | 2 | 4 |
| 7 | B | 4 | 1 | 1 | 1 | 33 | 33 | 2 | 2 | 4 |
| 8 | C | 2 | 1 | 1 | Increasing | 27 | 27 | 2 | 2 | 4 |
| | | | | | from 2- | | | | | |
| | | | | | 5 mm | | | | | |
| 9 | D | 2 | 1 | 1 | 1 | 0 | 0 | 0 | 0 | 165 |

| Example | Geometry | Z | a | a2 | b | | | d | d2 | r |
|---|---|---|---|---|---|---|---|---|---|---|
| No | Type | (mm) | (mm) | (mm) | (mm) | N | N2 | (mm) | (mm) | (mm) |
| 10 | E | 2 | 1 | none | 1 | 33 | NA | 2 | NA | 2 |
| 11 | E | 4 | 1 | none | 1 | 33 | NA | 2 | NA | 2 |
| 12 | E | 2 | 2 | none | 1 | 33 | NA | 2 | NA | 2 |
| 13 | E | 2 | 3 | none | 1 | 33 | NA | 2 | NA | 2 |
| 14 | F | 1.2 | 1 | 1 | 0.5 | 44 | 44 | 0.5 | 0.5 | 1 |
| 15 | F | 2 | 1 | 1 | 1 | 33 | 33 | 2 | 2 | 2 |
| 16 | F | 2 | 1 | 1 | 1 | 8 | 8 | 2 | 2 | 2 |

| Example | Geometry | Z | a | a2 | b | | | d | d2 | e | f |
|---|---|---|---|---|---|---|---|---|---|---|---|
| No | Type | (mm) | (mm) | (mm) | (mm) | N | N2 | (mm) | (mm) | (mm) | (mm) |
| 17 | G | 2 | 1 | none | 1 | 33 | NA | 2 | NA | 2 | 4 |
| 18 | G | 2 | 1 | none | 0 | 110 | NA | 1.5 | NA | 1.5 | 1.5 |
| 19 | H | 2 | 1 | 1 | 1 | 33 | 33 | 2 | 2 | 4 | 4 |
| 20 | I | 2 | 1 | 1 | 1 | 30 | 30 | 2 | 2 | 4 | 4 |

| Example | Geometry | Z | a | a2 | b | | | d | d2 | g | c |
|---|---|---|---|---|---|---|---|---|---|---|---|
| No | Type | (mm) | (mm) | (mm) | (mm) | N | N2 | (mm) | (mm) | (degree | (mm) |
| 21 | J | 2 | 1 | 1 | 1 | 30 | 30 | 2.75 | 2.75 | 60 | 4 |
| 22 | J | 1 | 1 | 1 | 1 | 30 | 30 | 2.75 | 2.75 | 60 | 4 |
| 23 | k | 2 | 1 | 1 | 1 | 13 | 13 | 30.2 | 30.2 | 15 | 1.2 |
| 24 | L | 2 | 1 | 1 | 1 | 28 | 28 | 2 | 2 | 75 | 4 |

| Example | Geometry | Z | a | a2 | b | | | d | d2 | r | r2 | c |
|---|---|---|---|---|---|---|---|---|---|---|---|---|
| No | Type | (mm) | (mm) | (mm) | (mm) | N | N2 | (mm) | (mm) | (mm) | (mm) | (mm) |
| 25 | M | 2 | 1 | 1 | 2.5 | 20 | 20 | 1 | 1 | 2 | 3 | NA |
| 26 | N | 2 | 1 | 1 | 2.5 | 20 | 29 | 1 | 1 | 1 | 2 | NA |
| 27 | N | 2 | 1 | 1 | 2.5 | 10 | 29 | 1 | 1 | 1 | 2 | NA |
| 28 | N | 2 | 1 | 1 | 2.5 | 5 | 29 | 1 | 1 | 1 | 2 | NA |
| 29 | O | 2 | 1 | 1 | 2.5 | 60 | 60 | 1 | 1 | NA | NA | 1 |
| 30 | O | 2 | 1 | 1 | 2.5 | 30 | 30 | 1 | 1 | NA | NA | 1 |
| 31 | O | 2 | 1 | 1 | 2.5 | 30 | 8 | 1 | 1 | NA | NA | 1 |

In each case the foamable fluid was a 1:10 mixture of Fairy™ liquid and water, with compressed air at 5 barg as the pressurised gas.

The Results were as Follows:

| | | Compressed | | |
|---|---|---|---|---|
| Example | Geometry | Air pressure | | Microfoam |
| Number | Type | Barg | Foam Quality | Pass/Fail |
| 1 | A | 5 | Fine foam formed | Pass |
| 2 | A | 5 | Fine foam formed | Pass |
| 3 | A | 5 | Fine foam base containing many large | Fail |
| | | | visible bubbles | |
| 4 | B | 5 | Fine foam formed | Pass |
| 5 | B | 5 | Fine foam formed | Pass |
| 6 | B | 5 | Liquid fine foam with visible large bubbles | Fail |
| 7 | B | 5 | Fine foam base containing some large | Fail |
| | | | visible bubbles | |
| 8 | C | 5 | Fine Foam Formed | Pass |
| 9 | D | 5 | Jetting liquid with large bubbles | Fail |
| 10 | E | 5 | Fine foam formed | Pass |
| 11 | E | 5 | Fine foam with a few large visible bubbles | Fail |
| 12 | E | 5 | Fine Foam Formed | Pass |
| 13 | E | 5 | Liquid fine foam containing many large | Fail |
| | | | visible bubbles | |
| 14 | F | 5 | Fine Foam Formed | Pass |
| 15 | F | 5 | Fine Foam Formed | Pass |
| 16 | F | 5 | Liquid fine foam containing many large | Fail |
| | | | visible bubbles | |
| 17 | G | 5 | Fine foam formed | Pass |
| 18 | G | 5 | Fine foam formed | Pass |
| 19 | H | 5 | Fine foam formed | Pass |
| 20 | I | 5 | Fine foam formed | Pass |
| 21 | J | 5 | Fine foam formed | Pass |
| 22 | J | 5 | Fine foam formed | Pass |
| 23 | k | 5 | Fine foam formed | Pass |
| 24 | L | 5 | Fine foam formed | Pass |
| 25 | M | 5 | Fast jet of liquid containing big bubbles | Fail |
| 26 | N | 5 | Fine foam formed | Pass |
| 27 | N | 5 | Fine foam formed | Pass |
| 28 | N | 5 | Fine foam formed | Pass |
| 29 | O | 5 | Fine foam formed | Pass |
| 30 | O | 5 | Fine foam formed | Pass |
| 31 | O | 5 | Liquid fine foam containing many large | Fail |
| | | | visible bubbles | |

It is to be noted that, in general there was success in generating a microfoam. However, it was found that by adjustment of parameters it is also possible for some combinations of geometric parameters to be unsuccessful. It is believed this is because the geometry generates insufficient shear for the bubble break-up mechanism to occur. In each case this is easily corrected by minor adjustment in the geometry values.

1. An apparatus for generating a microfoam, the apparatus comprising a first channel having an inlet and an outlet, a source of foamable fluid and a source of pressurised gas arranged to feed into the inlet, mix together and flow along the first channel to the outlet, the direction from the inlet to the outlet defining a bulk flow direction, along which first channel a microfoam is formed from the mixture;
wherein the first channel comprises a bulk flow stream that is substantially parallel to the bulk flow direction, and a plurality of deviation points, each deviation point having a paired joining point, spaced along the bulk flow stream;
each deviation point inducing a deviating portion of the bulk flow stream to be redirected away from the bulk flow stream;
each deviating portion reaching a fluidic dead-end and encountering a counter-flow of fluid, such that, in use, the fluidic dead-end induces a reversed deviating portion of the bulk flow stream directed towards the bulk flow stream;
the reversed deviating portion reaching the paired joining point where it rejoins the bulk flow stream before continuing until reaching the next pair of deviation and joining points;
wherein shear forces induced by the deviations of the bulk flow stream induce formation of the microfoam by interaction of the pressurised gas and the foamable fluid.

2. The apparatus according to claim 1, wherein each deviation point induces the deviating portion of the bulk flow stream to be redirected away from the bulk flow stream in a direction substantially perpendicular to the bulk flow stream, and the reversed deviating portion of the bulk flow stream is directed towards the bulk flow stream in a direction substantially perpendicular to the bulk flow stream.

3. The apparatus according to claim 1, wherein at each deviation point, the deviating portion comprises the entirety of the bulk flow stream.

4. The apparatus according to claim 1, wherein, at each deviation point, the portion of the bulk flow stream that is not deviated continues in a direction substantially parallel to the bulk flow direction until it reaches the joining point where it merges with the reversed deviating portion to re-form the bulk flow stream.

5. The apparatus according to claim 1, wherein, at each deviation point, at least 25% of the volumetric flow of the bulk flow stream is deviated into a deviated portion, preferably at least 50%.

6. The apparatus according to claim 1, which comprises no more channels than the first channel, and each fluidic dead-end is induced by a physical dead-end, the reversed deviating portion acting as the counter-flow of fluid.

7. The apparatus according to claim 1, which comprises a second channel, that shares the inlet and outlet with the first channel, the second channel defining a second bulk flow stream, that is substantially parallel to the bulk flow direction, and a plurality of deviation points, each deviation point having a paired joining point, spaced along the second bulk flow stream;
each deviation point inducing a deviating portion of the second bulk flow stream to be redirected away from the second bulk flow stream in a direction substantially perpendicular to the second bulk flow stream;
the deviating portion reaching a fluidic dead-end, such that, in use, the fluidic dead-end induces a reversed deviating portion of the second bulk flow stream directed towards the second bulk flow stream in a direction substantially perpendicular to the second bulk flow stream;
the reversed deviating portion reaching the paired joining point where it rejoins the second bulk flow stream before continuing until reaching the next pair of deviation and joining points;
wherein the deviating portions of the first and second bulk flow streams provide the respective counter-flows for their respective fluidic dead-ends.

8. The apparatus according to claim 7, wherein the net flow rate across each fluidic dead-end is substantially net zero.

9. The apparatus according to claim 7, wherein the second channel is a substantial mirror-image of the first channel.

10. The apparatus according to claim 7, wherein the source of pressurised gas and the source of foamable liquid fluid have a pressure of from 2 to 20 bar gauge, preferably from 3 to 15 bar gauge.

11. The apparatus according to claim 7, wherein the bulk flow streams, deviating portions and reversed deviating portions all have directions that are in the same plane.

12. The apparatus according to claim 7, wherein the cross-section of the bulk flow streams, deviating portions and reversed deviating portions are substantially rectangular.

13. The apparatus according to claim 7, wherein the average cross sectional area of the bulk flow stream is from 0.5 to 8 mm², preferably from 2 to 4 mm².

14. The apparatus according to claim 7, wherein the ratio of the length of the cross section to that of the width is less than 4.0, more preferably less than 3.0 and most preferably less than 2.0.

15. The apparatus according to claim 1, wherein the first channel has at least 10 pairs of deviation points and joining points, preferably at least 20 pairs of deviation points and joining points.

16. A method of forming a microfoam, the method involving the use of the apparatus according to claim 1.

17. An apparatus for generating a microfoam, the apparatus comprising:
a first channel having an inlet and an outlet, wherein a direction from the inlet to the outlet defines a bulk flow direction;
a source of foamable fluid arranged to feed into the inlet; and
a source of pressurized gas arranged to feed into the inlet and mix with the foamable fluid to create a mixture;
wherein the first channel defines:
a bulk flow stream of the mixture that is substantially parallel to the bulk flow direction; and
a plurality of deviation points spaced-along the bulk flow stream, wherein each deviation point has a paired joining point; and
wherein each deviation point is configured to induce a deviating portion of the bulk flow stream to be redirected away from a non-deviating portion of the bulk flow stream such that the deviating portion reaches a fluidic dead-end and encounters a counter-flow of the mixture, at which point a reversed deviating portion of the bulk flow stream is directed toward the paired joining point where it rejoins the non-deviating portion of the bulk flow stream.
